(19) United States
(12) Patent Application Publication
(10) Pub. No.: US 2020/0300427 A1
(43) Pub. Date: Sep. 24, 2020

(54) LED FLEXIBLE LIGHT STRIP AND PREPARATION METHOD THEREOF

(71) Applicant: SHENZHEN QUNCHENG OPTOELECTRONICS TECHNOLOGY CO., LTD, SHENZHEN CITY (CN)

(72) Inventor: ZUANHONG JIANG, NANPING CITY (CN)

(21) Appl. No.: 16/361,160

(22) Filed: Mar. 21, 2019

(51) Int. Cl. F21S 4/26; F21V 19/00; F21V 23/00; F21V 3/06

(52) U.S. Cl. CPC F21S 4/26; F21V 19/0025; F21Y 2115/10; F21V 3/062; F21V 23/001

(57) ABSTRACT

Disclosed are an LED flexible light strip and a preparation method thereof. The light strip comprises a plurality of LEDs, a strip-shaped carrier for carrying the LEDs and supplying power to the LEDs, and a protective sleeve is disposed on the outer periphery of the strip-shaped carrier and the LEDs. The strip-shaped carrier is a metal wire, the LEDs are soldered on the metal wire, and the protective sleeve is closely attached to the outer periphery of the metal wire and the LEDs to form a solid LED light strip. The LED flexible light strip provided by the present invention has excellent waterproof performance, and further makes the light strip have better foldability and a smaller diameter.

### BACKGROUND

### 1. Technical Field

The present invention relates to a decorative lamp, in particular to an LED flexible light strip and a preparation method thereof.

### 2. Description of Related Art

The existing LED flexible light strip generally comprises a flexible insulating sleeve, a flexible strip-shaped circuit board disposed in the flexible insulating sleeve, and a plurality of LEDs arranged at even intervals on the flexible strip-shaped circuit board. The light strip has a large gap between the bushing and the circuit board, that is, a hollow shaped light strip, and the use of a thick insulating sleeve causes the LED light strip to have the following defects: 1. poor foldability, 2. not waterproof, and 3. thick and too heavy.

### SUMMARY

An object of the present invention is to provide an LED flexible light strip to resolve the above-discussed deficiencies of the prior art.

In order to achieve the above object, the technical solution adopted by the present invention is as follows.

An LED flexible light strip comprises: a plurality of LEDs, a strip-shaped carrier for carrying the LEDs and supplying power to the LEDs, and a protective sleeve disposed on the outer periphery of the strip-shaped carrier and the LEDs; wherein the strip-shaped carrier is a metal wire on which the LEDs are soldered, and the protective sleeve is closely attached to the outer periphery of the metal wire and the LEDs to form a solid LED light strip.

Preferably, the metal wire is a single strand of enameled wire.

Preferably, the metal wire is a single strand of enameled copper wire.

Preferably, a transparent colloid is cured around the LEDs, and the transparent colloid is used for protecting the LEDs, diverging the light emitted by the LEDs, and forming an insulating layer on an exposed portion of the enameled wire.

Preferably, the LED flexible light strip has three metal lines arranged side by side, the three metal lines are respectively used as a positive line, a negative line and a loop line, and the LEDs are soldered to the positive line and the negative line; wherein, an end of the loop line is connected to an end of the positive line, and a head end of the loop line is connected to a head end of the negative line.

Preferably, the protective sleeve is injection molded from a transparent, insulating and high temperature resistant flexible material.

Preferably, the flexible material is silicone gel or polyethylene terephthalate.

A method for preparing an LED flexible light strip includes the following steps:

S1: selecting a rod body of a corresponding diameter according to a distance between adjacent LEDs;

S2: winding a metal wire on the surface of the rod body at a constant interval;

S3: feeding the rod body into a grinding device after winding the metal wire, and grinding the metal wire to form an exposed portion thereon;

S4: soldering the LEDs in the exposed portion;

S5: dispensing gel on the LEDs, and baking in a high temperature furnace to cure the glue; and

S6: feeding an end of the dispensed metal wire into an injection molding machine, starting the injection molding machine, and pulling the end of the metal wire to make the metal wire pass through an injection cavity at a uniform speed, and coating a transparent protective sleeve on the outer periphery of the metal wire and the LEDs.

Compared with the prior art, the present invention has at least the following beneficial effects.

The present invention adopts a metal wire as a carrier for carrying the LEDs and supplying power to the LEDs. Since the metal wire has better plasticity and a smaller cross section than the flexible circuit board, the LED flexible light strip is finer and has better foldability, and can thus be easily constructed into a style that people like. In addition, since there is no gap between the LEDs and its carrier and the protective sleeve, the three are integrated. Therefore, the LED flexible light strip has excellent waterproof performance, and the light strip is smaller in diameter and lighter in weight.

### BRIEF DESCRIPTION OF THE DRAWINGS

FIG. 1 is a schematic structural view of an LED flexible light strip of a first embodiment;

FIG. 2 is a cross-sectional view taken along line A-A of FIG. 1;

FIG. 3 is a cross-sectional view taken along line B-B of FIG. 1;

FIG. 4 is a schematic structural view of an LED flexible light strip of a second embodiment;

FIG. 5 is a cross-sectional view taken along line C-C of FIG. 4;

FIG. 6 is a cross-sectional view taken along line D-D of FIG. 4;

FIG. 7 is a schematic view showing the structure of a rod body used for preparing a light strip;

FIG. 8 is a state diagram after winding a metal wire;

FIG. 9 is a state diagram after soldering the LED; and

FIG. 10 is a state diagram after dispensing gel.

### DESCRIPTION OF THE EXEMPLARY EMBODIMENTS

The present invention will be further described below in conjunction with the drawings and embodiments.

### First Embodiment

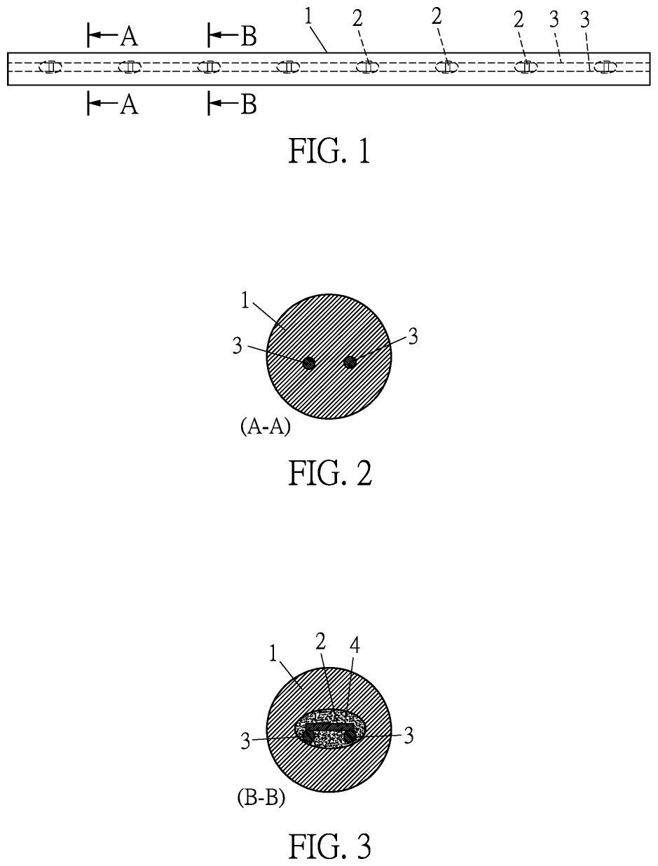

Referring to FIG. 1 to FIG. 3, an LED flexible light strip of the present invention includes a plurality of LEDs 2, a strip-shaped carrier for carrying the LEDs 2 and supplying power to the LEDs 2, and a protective sleeve 1 disposed on the outer periphery of the strip-shaped carrier and the LEDs 2. Here, the strip-shaped carrier is two metal wires 3, the LEDs 2 are soldered on the two metal wires 3, and the protective sleeve 1 is closely attached to the outer periphery of the metal wires 3 and the LEDs 2 to form a solid LED light strip.

The above-mentioned metal wire 3 is used as a carrier for carrying the LEDs 2 and supplying power to the LEDs 2. Since the metal wire has better plasticity and smaller volume than the flexible circuit board, the LED flexible light strip is finer and has better foldability. In addition, since there is no gap between the LEDs 2 and the metal wire 3 and the protective sleeve 1, the three are integrated. Therefore, the LED flexible light strip has excellent waterproof performance, and the light strip is smaller in diameter and lighter in weight.

The metal wire 3 is preferably a single strand of enameled wire. Thus, even if some parts of the two metal wires 3 are in contact, no short circuit occurs, so that the yield of the product can be improved. The metal wire 3 is more preferably a single strand of enameled copper wire, which further improves the foldability of the light strip.

Referring to FIG. 3, a transparent colloid 4 is further cured around the LEDs 2. The transparent colloid 4 here has the following various uses.
1) During the preparation of the light strip, the LEDs 2 can be protected.
2) During use, the transparent colloid 4 can scatter the light emitted by the LEDs 2.
3) Before soldering the LEDs, the insulating paint for the soldering position of the enameled wire needs to be removed to form an exposed portion, and the transparent colloid 4 forms an insulating layer on the exposed portion of the enameled wire, thereby avoiding shorting of the exposed portions of the two metal wires 3, so as to further improve the yield of the product.

The protective sleeve 1 is injection molded from a transparent, insulating and high temperature resistant flexible material, preferably but not limited to silicone gel or polyethylene terephthalate (PET).

### Second Embodiment

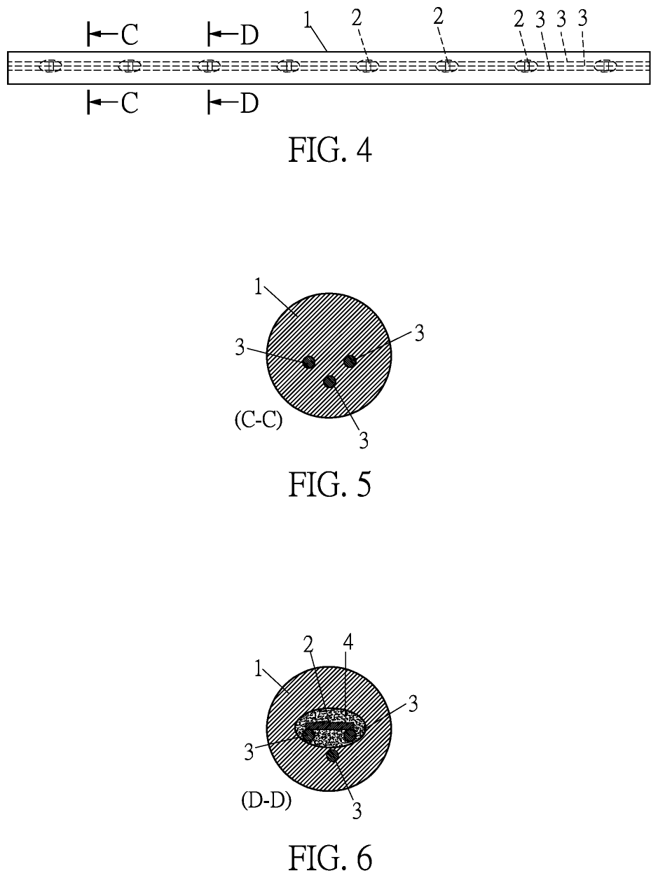

Referring to FIG. 4 to FIG. 6, the LED flexible light strip of the second embodiment includes a plurality of LEDs 2, a strip-shaped carrier for carrying the LEDs 2 and supplying power to the LEDs 2, and a protective sleeve 1 disposed on the outer periphery of the strip-shaped carrier and the LEDs 2. Here, the LED flexible light strip has three metal wires 3 arranged side by side, three of the metal wires 3 are respectively used as a positive line, a negative line and a loop line, and the LEDs 2 are soldered to the positive line and the negative line. An end of the loop line is connected to an end of the positive line, a head end of the loop line is connected to a head end of the negative line, and the protective sleeve 1 is closely attached to the outer periphery of the metal line 3 and the LEDs 2 to form a solid LED light strip.

Compared to the first embodiment, a metal wire 3 is added in the second embodiment, and the additional metal wire is used as a loop line.

In most LED light strips, multiple LEDs are connected in parallel between the positive and negative poles of the power supply. If the strip is too long, the brightness of the light emitted by the LEDs at the front and rear ends of the light strip will be different because of the voltage reduction, which will affect the lighting effect. By virtue of the addition of the above-mentioned loop line, it can be ensured that the brightness of the light emitted by the LEDs is uniform within a length of ten meters.

A method for preparing the aforementioned LED flexible light strip comprises the following steps.

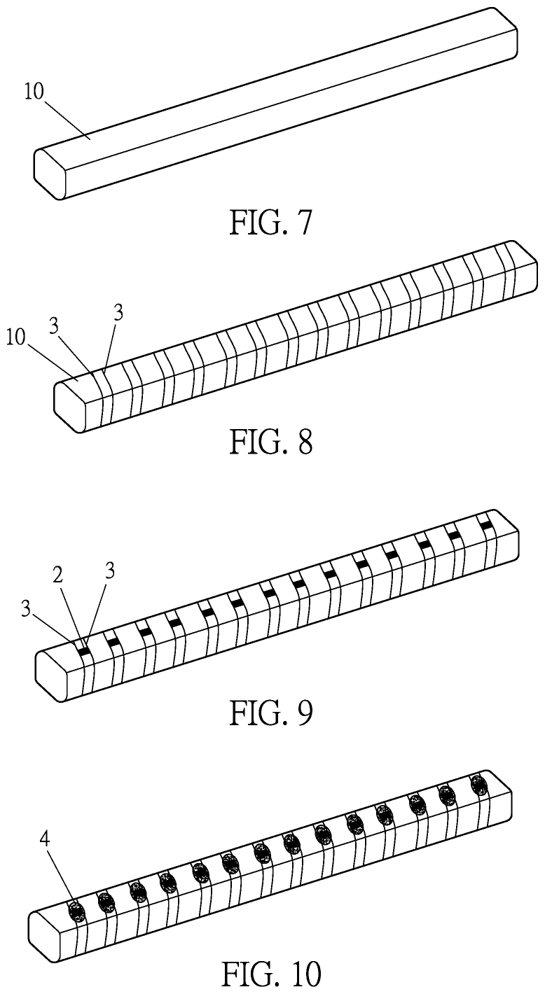

S1: the rod body 10 of a corresponding diameter is selected according to a distance between adjacent LEDs 2, as shown in FIG. 7. The diameter of the rod body 10 increases as the distance between adjacent LEDs 2 increases, with the purpose of making all of the LEDs 2 on the same surface of the rod body 10.

S2: the metal wire 3 is wound on the surface of the rod body 10 at a constant interval, as shown in FIG. 8. The spacing between the two wires 3 matches the size of each of the LEDs 2.

S3: The rod body 10 is fed into a grinding device after winding the metal wire 3, and the metal wire 3 is ground to form an exposed portion thereon, and the exposed portion is used for soldering the LEDs 2.

S4: The LEDs 2 are soldered on the exposed portion, as shown in FIG. 9. The specific soldering process includes: applying tin, then mounting the LEDs through surface mount equipment, and finally drying.

S5: Gel dispensing is performed on the LEDs 2 and the glue is baked in a high temperature furnace to be cured to form a colloid 4, as shown in FIG. 10.

S6: An end of the dispensed metal wire 3 is fed into an injection molding machine, the injection molding machine is started, and the end of the metal wire 3 is pulled to make the metal wire 3 pass through an injection molding cavity at a uniform speed, and the transparent protective sleeve 1 is coated on the outer periphery of the metal wire 3 and the LEDs 2. Thus, the above solid LED flexible light strip is produced.

The present invention has been described in detail with reference to the preferred embodiments thereof, and the detailed description is not to be construed as limiting the scope of the invention. Various modification, equivalent replacement, and the like performed by those skilled in the art to the above-described embodiments under the present invention should be included in the scope of the present invention.

1. An LED flexible light strip, comprising:
a plurality of LEDs;
a carrier for carrying the LEDs and supplying power to the LEDs; and
a protective sleeve disposed on the carrier and the periphery of the LEDs,
wherein the carrier is a metal wire;
wherein the plurality of LEDs are soldered on the metal wire;
wherein the protective sleeve is closely attached to the outer periphery of the metal wire and the LEDs to form a solid LED light strip;
wherein the metal wire is single strand of enameled wire;
wherein a transparent colloid is cured around the LEDs and disposed within the protective sleeve around the plurality of LEDs, and the transparent colloid is used for protecting the LEDs, scattering the light emitted by the LEDs, and forming an insulating layer on an exposed portion of the enameled wire;
wherein the LED flexible light strip has three metal lines arranged side by side, and the three metal lines are respectively used as a positive line, a negative line and a third line; and
wherein the LEDs are soldered to the positive line and the negative line, an end of the third line is connected to an end of the positive line, and a head end of the third line is connected to a head end of the negative line.

2. (canceled)

3. The LED flexible light strip according to claim 1, wherein the metal wire is single strand of enameled copper wire.

4-6. (canceled)

7. The LED flexible light strip according to claim 1, wherein the protective sleeve is injection molded from a transparent, insulating and high temperature resistant flexible material.

8. The LED flexible light strip according to claim 7, wherein the flexible material is silicone gel or polyethylene terephthalate.

9. A method for preparing an LED flexible light strip, comprising the steps of:
S1: selecting a rod body of a corresponding diameter according to a distance between adjacent LEDs;
S2: winding a metal wire on the surface of the rod body at a constant interval;
S3: feeding the rod body into a grinding device after winding the metal wire, and grinding the metal wire to form an exposed portion thereon;
S4: soldering the LEDs in the exposed portion;
S5: dispensing gel on the LEDs, and baking in a high temperature furnace to cure the glue; and
S6: feeding an end of the dispensed metal wire into an injection molding machine, starting the injection molding machine, and pulling the end of the dispensed metal wire to make the dispensed metal wire pass through an injection cavity at a uniform speed, and coating a transparent protective sleeve on the outer periphery of the dispensed metal wire and the LEDs.
